(19) United States
(12) Patent Application Publication
(10) Pub. No.: US 2017/0133150 A1
(43) Pub. Date: May 11, 2017

(54) CUSTOMIZED SMD POWER INDUCTOR AND METHOD OF MANUFACTURING THE SAME

(71) Applicant: INPAQ TECHNOLOGY CO., LTD., Miaoli County (TW)

(72) Inventor: WEI-CHIH LEE, NEW TAIPEI CITY (TW)

(21) Appl. No.: 14/934,180

(22) Filed: Nov. 6, 2015

(51) Int. Cl. H01F 27/29; H01F 27/32; H01F 27/24; H01F 27/28; H01F 41/04; H01F 41/10

(52) U.S. Cl. CPC H01F 27/292; H01F 41/042; H01F 41/10; H01F 27/24; H01F 27/2804; H01F 27/32

(57) ABSTRACT

A customized SMD power inductor includes a magnetic substrate, a coil structure, a magnetic coating structure, and a terminal electrode structure. The coil structure is disposed on the magnetic substrate. The magnetic coating structure is disposed on the magnetic substrate to cover the coil structure. The magnetic coating structure includes a middle coating layer and a top coating layer, and the middle coating layer has a middle filling portion and a surrounding perimeter portion. The magnetic substrate has a first predetermined relative permeability, the surrounding perimeter portion has a second predetermined relative permeability, the middle filling portion has a third predetermined relative permeability, and the top coating layer has a fourth predetermined relative permeability. The electrical property of the customized SMD power inductor is adjusted according to numerical values of the first, the second, the third, and the fourth predetermined relative permeability.

### BACKGROUND OF THE INVENTION

1. Field of the Invention

The instant disclosure relates to a power inductor and a method of manufacturing the same, and more particularly to a customized SMD (Surface Mount Device) power inductor and a method of manufacturing the same.

2. Description of Related Art

The prior inductor includes a circuit board, a coil attached to the circuit board, and an enclosure. From the enclosure there extend a first conductor and a second conductor each respectively welded to welding pads. The coil is a helical winding body with multiple turns of an erected rectangular cross sectional flat wire. The coil includes an inner side end and an outer side end, and a lead frame is attached to the winding body with its two terminals each respectively welded to the inner side end and the outer side end of the winding body. Afterwards the winding body with both welded conductors is set in a mold, and then the mold filled with preferably, a colloidal magnetic powder. After the magnetic powder is dried and hardened, the lead frame is severed and taken away. The finished product of the inductor is obtained.

### SUMMARY OF THE INVENTION

One aspect of the instant disclosure relates to a customized SMD power inductor and a method of manufacturing the same.

One of the embodiments of the instant disclosure provides a customized SMD power inductor, comprising a magnetic substrate, a coil structure, a magnetic coating structure, and a terminal electrode structure. The coil structure is disposed on the magnetic substrate. The coil structure includes a conductive extending portion and an insulation extending portion for enclosing the conductive extending portion, the conductive extending portion and the insulation extending portion are extended along a predetermined track, and the conductive extending portion has a first conductive terminal and a second conductive terminal opposite to the first conductive terminal. The magnetic coating structure is disposed on the magnetic substrate to cover the coil structure. The magnetic coating structure includes a middle coating layer disposed on the magnetic substrate and connected to the insulation extending portion and a top coating layer disposed on the coil structure and the middle coating layer, the conductive extending portion is insulated from the magnetic coating structure through the insulation extending portion, the first conductive terminal and the second conductive terminal of the conductive extending portion both are exposed from the middle coating layer, and the middle coating layer has a surrounding perimeter portion. The terminal electrode structure includes a first terminal electrode portion electrically contacting the first conductive terminal and a second terminal electrode portion corresponding to the first terminal electrode portion and electrically contacting the second conductive terminal. The first terminal electrode portion is disposed on a lateral side of the middle coating layer for enclosing a portion of the magnetic substrate and a portion of the top coating layer, and the second terminal electrode portion is disposed on another lateral side of the middle coating layer for enclosing another portion of the magnetic substrate and another portion of the top coating layer. More particularly, the magnetic substrate has a first predetermined relative permeability, the surrounding perimeter portion has a second predetermined relative permeability, the middle coating layer has a third predetermined relative permeability, and the top coating layer has a fourth predetermined relative permeability, the third predetermined relative permeability of the middle coating layer is larger than or equal to the fourth predetermined relative permeability of the top coating layer, the fourth predetermined relative permeability of the top coating layer is larger than or equal to the first predetermined relative permeability of the magnetic substrate, and the first predetermined relative permeability of the magnetic substrate is larger than or equal to the second predetermined relative permeability of the surrounding perimeter portion. Therefore, the electrical property of the customized SMD power inductor is adjusted according to numerical values of the first predetermined relative permeability, the second predetermined relative permeability, the third predetermined relative permeability, and the fourth predetermined relative permeability.

Another one of the embodiments of the instant disclosure provides a customized SMD power inductor, comprising a magnetic substrate, a coil structure, a magnetic coating structure, and a terminal electrode structure. The coil structure is disposed on the magnetic substrate. The coil structure includes a conductive extending portion and an insulation extending portion for enclosing the conductive extending portion, the conductive extending portion and the insulation extending portion are extended along a predetermined track, and the conductive extending portion has a first conductive terminal and a second conductive terminal opposite to the first conductive terminal. The magnetic coating structure is disposed on the magnetic substrate to cover the coil structure. The magnetic coating structure includes a middle coating layer disposed on the magnetic substrate and connected to the insulation extending portion and a top coating layer disposed on the coil structure and the middle coating layer, the conductive extending portion is insulated from the magnetic coating structure through the insulation extending portion, the first conductive terminal and the second conductive terminal of the conductive extending portion both are exposed from the middle coating layer, and the middle coating layer has a surrounding perimeter portion. The terminal electrode structure includes a first terminal electrode portion electrically contacting the first conductive terminal and a second terminal electrode portion corresponding to the first terminal electrode portion and electrically contacting the second conductive terminal. The first terminal electrode portion is disposed on a lateral side of the middle coating layer for enclosing a portion of the magnetic substrate and a portion of the top coating layer, and the second terminal electrode portion is disposed on another lateral side of the middle coating layer for enclosing another portion of the magnetic substrate and another portion of the top coating layer. More particularly, the magnetic substrate is made of a first predetermined soft magnetic material, the insulation extending portion is made of a second predetermined soft magnetic material, the middle coating layer is made of a third predetermined soft magnetic material, the top coating layer is made of a fourth predetermined soft magnetic material, and the first predetermined soft magnetic material, the second predetermined soft magnetic material, the third predetermined soft magnetic material, and the fourth predetermined soft magnetic material are totally different from each other or partially different from each other. Therefore, the electrical property of the customized SMD power inductor is adjusted according to the first predetermined soft magnetic material, the second predetermined soft magnetic material, the third predetermined soft magnetic material, and the fourth predetermined soft magnetic material.

Yet another one of the embodiments of the instant disclosure provides a method of manufacturing a customized SMD power inductor, comprising: providing an initial magnetic substrate unit, wherein the initial magnetic substrate unit is composed of a plurality of magnetic substrates; forming a coil structure unit on the initial magnetic substrate unit, wherein the coil structure unit is composed of a plurality of coil structures respectively disposed on the magnetic substrate, wherein each coil structure includes a conductive extending portion and an insulation extending portion for enclosing the conductive extending portion, and the conductive extending portion and the insulation extending portion are extended along a predetermined track; forming an initial magnetic coating structure unit on the initial magnetic substrate unit to cover the coil structure unit, wherein the initial magnetic coating structure unit is composed of a plurality of magnetic coating structures respectively disposed on the magnetic substrates to respectively cover the coil structures, each magnetic coating structure includes a middle coating layer disposed on the magnetic substrate and connected to the insulation extending portion and a top coating layer disposed on the coil structure and the middle coating layer, the conductive extending portion is insulated from the magnetic coating structure through the insulation extending portion, and the middle coating layer has a surrounding perimeter portion; cutting the initial magnetic substrate unit, the coil structure unit, and the initial magnetic coating structure unit to form a plurality of granulated electronic components, wherein the initial magnetic substrate unit is cut into the magnetic substrates separated from each other, the coil structure unit is cut into the coil structures separated from each other, the initial magnetic coating structure unit is cut into the magnetic coating structures separated from each other, and each granulated electronic component is composed of the magnetic substrate, the coil structure, and the magnetic coating structure; setting the granulated electronic components at a predetermined temperature substantially between 200° C. and 900° C. during a densification treatment; and then respectively forming a plurality of terminal electrode structures on the granulated electronic components, wherein the terminal electrode structure includes a first terminal electrode portion and a second terminal electrode portion respectively disposed on two opposite lateral sides of the granulated electronic component to finish the manufacture of the customized SMD power inductor. More particularly, the conductive extending portion has a first conductive terminal and a second conductive terminal opposite to the first conductive terminal, the first conductive terminal and the second conductive terminal of the conductive extending portion both are exposed from the middle coating layer to respectively electrically contacting the first conductive terminal portion and the second terminal electrode portion, wherein the first terminal electrode portion is disposed on a lateral side of the middle coating layer for enclosing a portion of the magnetic substrate and a portion of the top coating layer, and the second terminal electrode portion is disposed on another lateral side of the middle coating layer for enclosing another portion of the magnetic substrate and another portion of the top coating layer.

Therefore, in one of embodiments, the electrical property of the customized SMD power inductor can be adjusted or determined to pass muster with customer according to numerical values of the first, the second, the third, and the fourth predetermined relative permeability, in order to pass muster with different customers. In another one of embodiments, the electrical property of the customized SMD power inductor can be adjusted or determined according to the first, the second, the third, and the fourth predetermined soft magnetic materials, in order to pass muster with different customers.

To further understand the techniques, means and effects of the instant disclosure applied for achieving the prescribed objectives, the following detailed descriptions and appended drawings are hereby referred to, such that, and through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

The accompanying drawings are included to provide a further understanding of the instant disclosure, and are incorporated in and constitute a part of this specification. The drawings illustrate exemplary embodiments of the instant disclosure and, together with the description, serve to explain the principles of the instant disclosure.

FIG. 1 shows a perspective, schematic view of the coil structure disposed on the magnetic substrate according to the instant disclosure;

FIG. 2 shows a perspective, schematic view of the customized SMD power inductor according to one of embodiments of the instant disclosure;

FIG. 3 shows a cross-sectional view taken along the section line A-A of FIG. 2;

FIG. 4 shows a cross-sectional, schematic view of the customized SMD power inductor according to another one of embodiments of the instant disclosure;

FIG. 5 shows a flowchart of the method of manufacturing the customized SMD power inductor according to the instant disclosure;

FIG. 6 shows a cross-sectional, schematic view of the manufacturing steps S100 and S102 of the method of manufacturing the customized SMD power inductor according to the instant disclosure;

FIG. 7 shows a cross-sectional, schematic view of the manufacturing step S104 of the method of manufacturing the customized SMD power inductor according to the instant disclosure;

FIG. 8 shows a cross-sectional, schematic view of the manufacturing steps S106 and S108 of the method of manufacturing the customized SMD power inductor according to the instant disclosure;

FIG. 9 shows a cross-sectional, schematic view of the manufacturing step S110 of the method of manufacturing the customized SMD power inductor according to the instant disclosure; and

FIG. 10 shows a curve diagram of direct current bias (amps) against inductance value (μH) according to different embodiments of the customized SMD power inductor of the instant disclosure.

### DETAILED DESCRIPTION OF THE PREFERRED EMBODIMENTS

The embodiments of the customized SMD power inductor and the method of manufacturing the same” of the instant disclosure are described. Other advantages and objectives of the instant disclosure can be easily understood by one skilled in the art from the disclosure. The instant disclosure can be applied in different embodiments. Various modifications and variations can be made to various details in the description for different applications without departing from the scope of the instant disclosure. The drawings of the instant disclosure are provided only for simple illustrations, but are not drawn to scale and do not reflect the actual relative dimensions. The following embodiments are provided to describe in detail the concept of the instant disclosure, and are not intended to limit the scope thereof in any way.

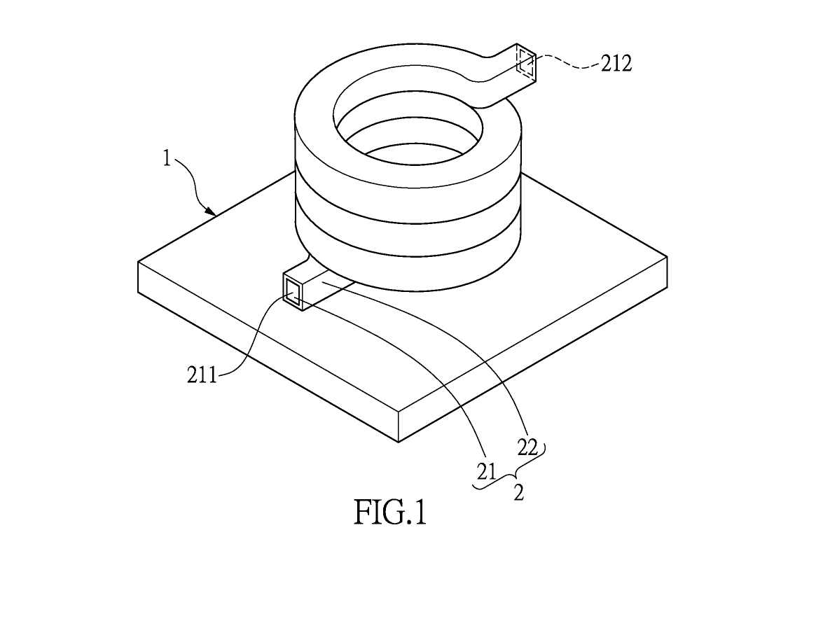

Referring to FIG. 1 to FIG. 3, the instant disclosure provides a customized SMD power inductor Z, comprising a magnetic substrate 1, a coil structure 2, a magnetic coating structure 3, and a terminal electrode structure 4.

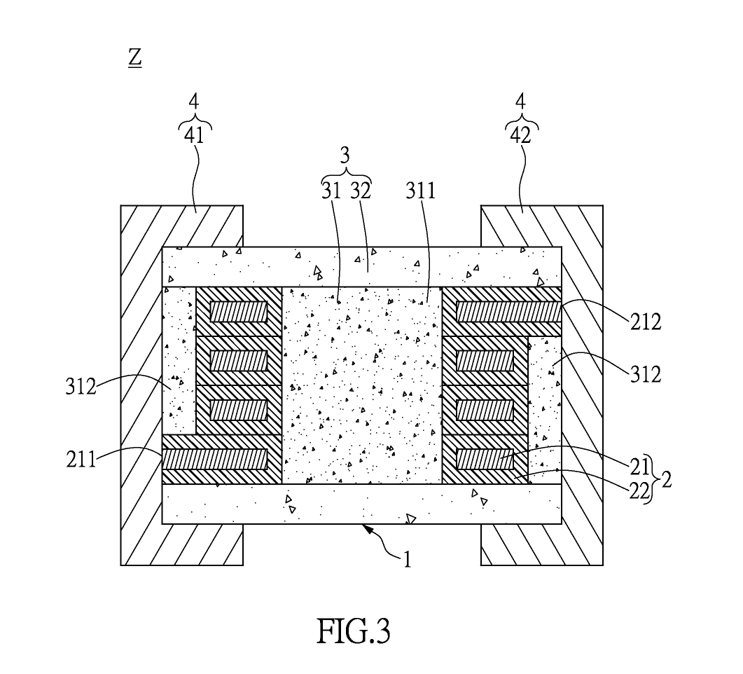

First, referring to FIG. 1 and FIG. 3, the coil structure 2 is disposed on the magnetic substrate 1. More particularly, the coil structure 2 includes a conductive extending portion 21 and an insulation extending portion 22 for enclosing or encapsulating the conductive extending portion 21, and the conductive extending portion 21 has a first conductive terminal 211 and a second conductive terminal 212 opposite to the first conductive terminal 211. In addition, both the conductive extending portion 21 and the insulation extending portion 22 are extended along a predetermined track. For example, as shown in FIG. 1, both the conductive extending portion 21 and the insulation extending portion 22 are extended along an upward spiral track or an upward meandering track, and the conductive extending portion 21 and the insulation extending portion 22 are extended concurrently to form, such as an inner extending ring and an outer extending ring, respectively. In addition, the conductive extending portion 21 may be one of a conductive metal line, a conductive metal foil, a conductive printed layer formed by printing, and a conductive electroplated layer formed by electroplating, but that is merely an example and is not meant to limit the instant disclosure.

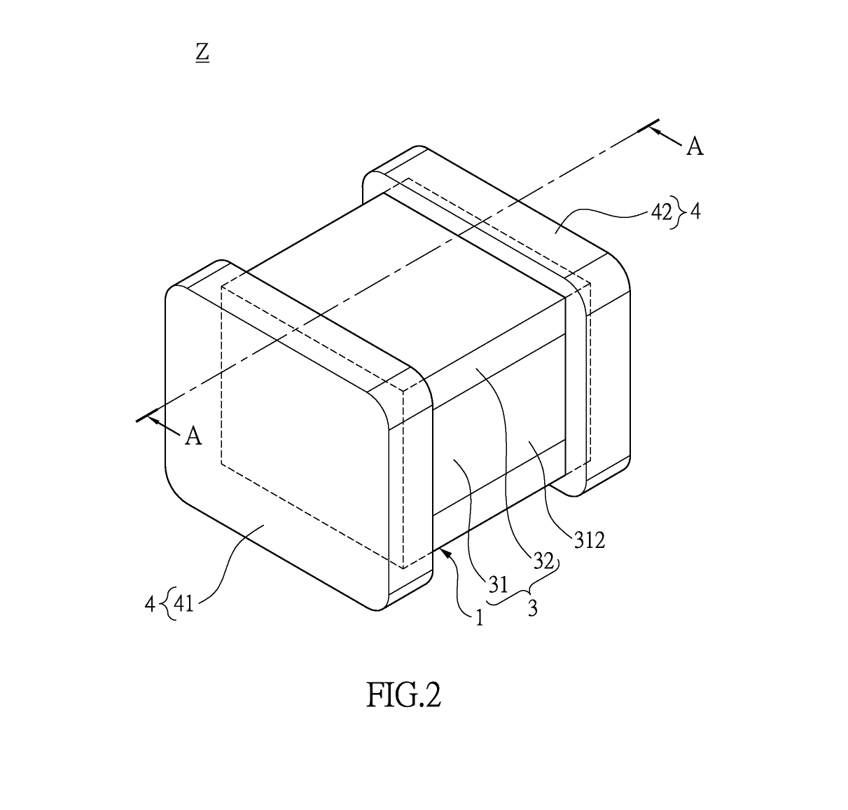

Moreover, referring to FIG. 2 and FIG. 3, the magnetic coating structure 3 is disposed on the magnetic substrate 1 to cover the coil structure 2. More particularly, the magnetic coating structure 3 includes a middle coating layer 31 disposed on the magnetic substrate 1 and connected to the insulation extending portion 22 and a top coating layer 32 disposed on the coil structure 2 and the middle coating layer 31. The conductive extending portion 21 is insulated from the magnetic coating structure 3 through the insulation extending portion 22, and both the first conductive terminal 211 and the second conductive terminal 212 of the conductive extending portion 21 are exposed from the middle coating layer 31. For example, the middle coating layer 31 has a middle filling portion 311 seamlessly connected to the insulation extending portion 22 and surrounded by the insulation extending portion 22 and a surrounding perimeter portion 312 (such as a surrounding peripheral portion) seamlessly connected to the insulation extending portion 22 for surrounding the insulation extending portion 22, and the top coating layer 32 is seamlessly connected to the middle filling portion 311, the surrounding perimeter portion 312, and the insulation extending portion 22. Therefore, both the middle coating layer 31 and the top coating layer 32 are seamlessly connected to the insulation extending portion 22, so that there is no any gap or vacant space between the insulation extending portion 22 and the middle coating layer 31, and there is also no any gap or vacant space between the insulation extending portion 22 and the top coating layer 32.

Furthermore, referring to FIG. 2 and FIG. 3, the terminal electrode structure 4 includes a first terminal electrode portion 41 electrically contacting the first conductive terminal 211 and a second terminal electrode portion 42 corresponding to the first terminal electrode portion 41 and electrically contacting the second conductive terminal 212. For example, the first terminal electrode portion 41 is disposed on a lateral side of the middle coating layer 31 for enclosing or encapsulating a portion of the magnetic substrate 1 and a portion of the top coating layer 32, and the second terminal electrode portion 42 is disposed on another lateral side of the middle coating layer 31 for enclosing or encapsulating another portion of the magnetic substrate 1 and another portion of the top coating layer 32.

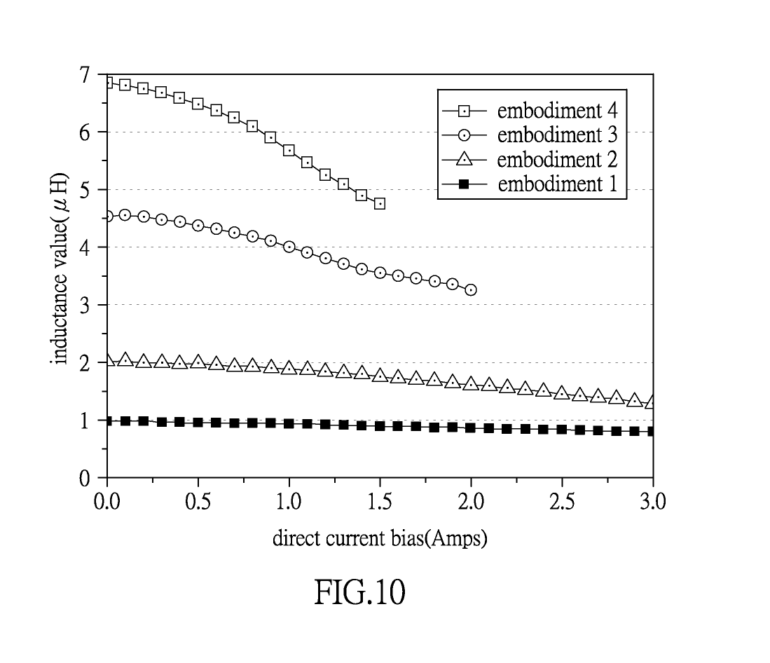

Please note, the magnetic substrate 1 has a first predetermined relative permeability (μ1), the surrounding perimeter portion 312 of the middle coating layer 31 has a second predetermined relative permeability (μ2), the middle filling portion 311 of the middle coating layer 31 has a third predetermined relative permeability (μ3), and the top coating layer 32 has a fourth predetermined relative permeability (μ4). More particularly, the third predetermined relative permeability (μ3) of the middle filling portion 311 of the middle coating layer 31 is larger than or equal to the fourth predetermined relative permeability (μ4) of the top coating layer 32, the fourth predetermined relative permeability (μ4) of the top coating layer 32 is larger than or equal to the first predetermined relative permeability (μ1) of the magnetic substrate 1, and the first predetermined relative permeability (μ1) of the magnetic substrate 1 is larger than or equal to the second predetermined relative permeability (μ2) of the surrounding perimeter portion 312. For example, the range of any one of the first predetermined relative permeability (μl), the second predetermined relative permeability (μ2), the third predetermined relative permeability (μ3), and the fourth predetermined relative permeability (μ4) is substantially between 1 and 53, such as approximately between 1 and 26, or approximately between 26 and 53, so that the first predetermined relative permeability (μ1), the second predetermined relative permeability (μ2), the third predetermined relative permeability (μ3), and the fourth predetermined relative permeability (μ4) conform to the following condition: 53≧μ3≧μ4≧μ1≧μ2≧1, but that is merely an example and is not meant to limit the instant disclosure. For example, FIG. 10 shows a curve diagram of direct current bias (amps) against inductance value (μH) according to different embodiments 1-4 (i.e., the first, the second, the third, and the fourth predetermined relative permeability (μ1, μ2, μ3, and μ4) of the customized SMD power inductor Z of the instant disclosure.

| | | | | | Initial |
|---|---|---|---|---|---|
| | | | | | inductance |
| | □μ1 | □μ2 | □μ3 | □μ4 | value (μH) |
| Embodiment 1 | 15 | 15 | 15 | 15 | 0.99 |
| Embodiment 2 | 20 | 15 | 35 | 20 | 1.95 |
| Embodiment 3 | 30 | 20 | 60 | 30 | 4.51 |
| Embodiment 4 | 50 | 30 | 80 | 50 | 6.84 |

Therefore, the electrical property (such as inductance value, rated current, direct current resistance, and working temperature range) of the customized SMD power inductor Z can be adjusted or determined to pass muster with customer according to numerical values of the first predetermined relative permeability (μl), the second predetermined relative permeability (μ2), the third predetermined relative permeability (μ3), and the fourth predetermined relative permeability (μ4). In other words, the customized SMD power inductor Z of the instant disclosure can provide a customized electrical property by adjusting numerical values of the first predetermined relative permeability (μ1), the second predetermined relative permeability (μ2), the third predetermined relative permeability (μ3), and the fourth predetermined relative permeability (μ4), in order to pass muster with different customers.

More particularly, the magnetic substrate 1 is made of a first predetermined soft magnetic material, the insulation extending portion 22 is made of a second predetermined soft magnetic material, the middle coating layer 31 is made of a third predetermined soft magnetic material, the top coating layer 32 is made of a fourth predetermined soft magnetic material, and the first predetermined soft magnetic material, the second predetermined soft magnetic material, the third predetermined soft magnetic material, and the fourth predetermined soft magnetic material are totally different from each other or partially different from each other. For example, the predetermined soft magnetic material may be an iron based metal (such as CIP (Carbonyl Iron Power), sendust (FeAlSi alloy), FeCrSi alloy, or FeSi alloy etc.), or the predetermined soft magnetic material may be ferrite based oxide, Ni—Zn ferrite, Ni—Cu—Zn ferrite, or Mn—Zn ferrite etc.

Therefore, the electrical property (such as inductance value, rated current, direct current resistance, and working temperature range) of the customized SMD power inductor Z can be adjusted or determined according to the first predetermined soft magnetic material, the second predetermined soft magnetic material, the third predetermined soft magnetic material, and the fourth predetermined soft magnetic material. In other words, the customized SMD power inductor Z of the instant disclosure can provide a customized electrical property by adjusting material characteristics of the first predetermined soft magnetic material, the second predetermined soft magnetic material, the third predetermined soft magnetic material, and the fourth predetermined soft magnetic material, in order to pass muster with different customers.

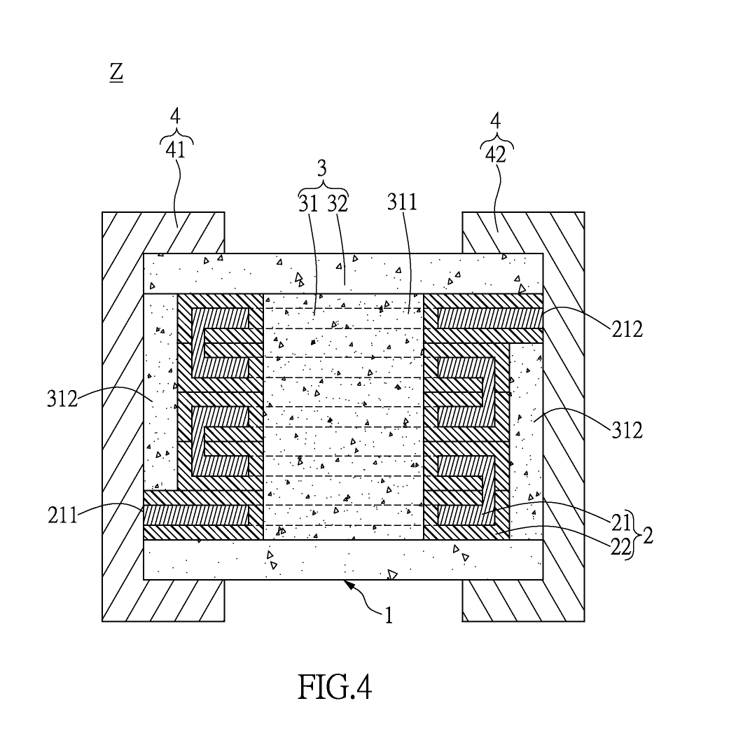

Please note, as shown in FIG. 4, the conductive extending portion 21 can be extended along an upward meandering track according to different requirements.

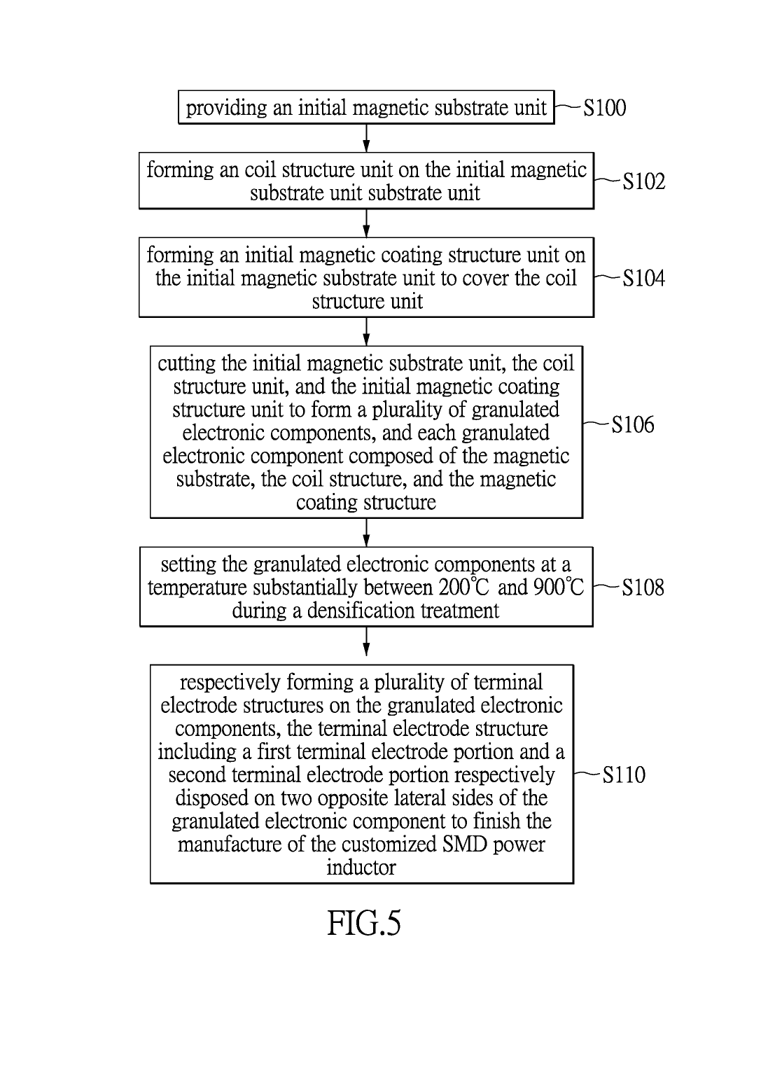

Referring to FIG. 5 to FIG. 9, the instant disclosure further comprises a method of manufacturing a customized SMD power inductor Z, comprising the following steps:

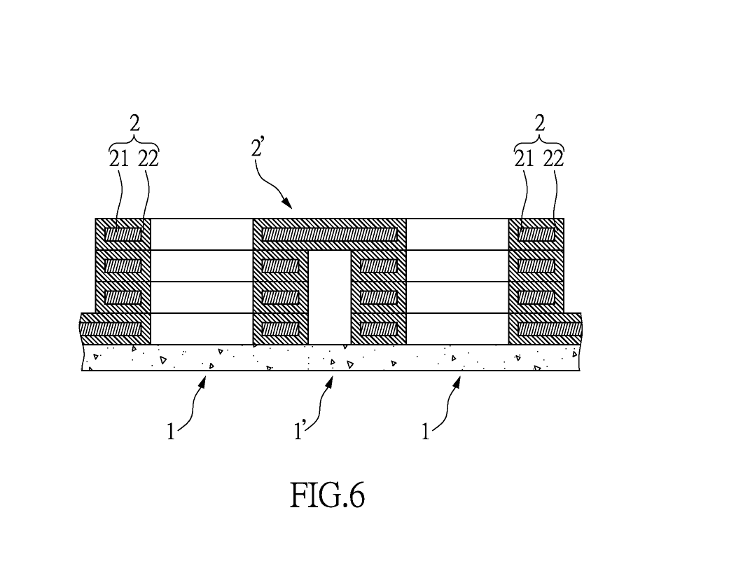

First, referring to FIG. 5 and FIG. 6, the step S100 is: providing an initial magnetic substrate unit 1′ (S100), and the initial magnetic substrate unit 1′ is composed of a plurality of magnetic substrates 1. Next, the step S102 is: forming a coil structure unit 2′ on the initial magnetic substrate unit 1′ (S102), and the coil structure unit 2′ is composed of a plurality of coil structures 2 respectively disposed on the magnetic substrate 1. More particularly, each coil structure 2 includes a conductive extending portion 21 and an insulation extending portion 22 for enclosing the conductive extending portion 21, and the conductive extending portion 21 and the insulation extending portion 22 both are extended along a predetermined track. For example, the initial magnetic substrate unit 1′ may be a semiconductor wafer.

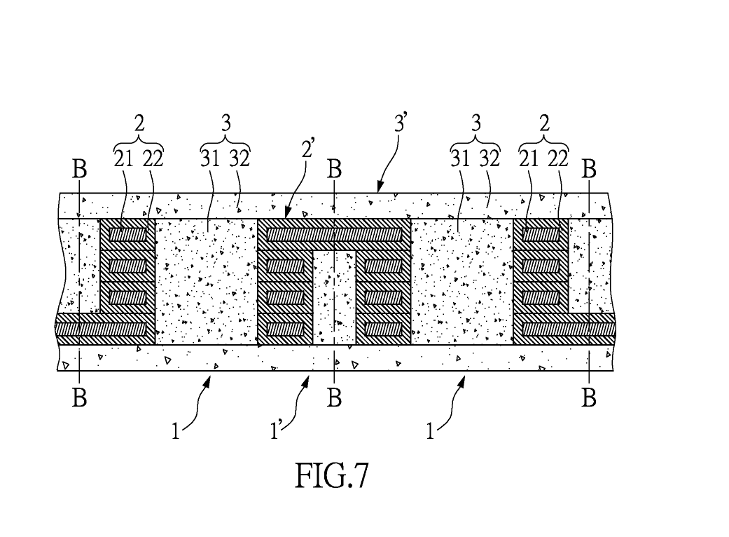

Afterward, referring to FIG. 5 and FIG. 7, the step S104 is: forming an initial magnetic coating structure unit 3′ on the initial magnetic substrate unit 1′ to cover the coil structure unit 2′ (S104), and the initial magnetic coating structure unit 3′ is composed of a plurality of magnetic coating structures 3 respectively disposed on the magnetic substrates 1 to respectively cover the coil structures 2. More particularly, each magnetic coating structure 3 includes a middle coating layer 31 disposed on the magnetic substrate 1 and connected to the insulation extending portion 22 and a top coating layer 32 disposed on the coil structure 2 and the middle coating layer 31, and the conductive extending portion 21 is insulated from the magnetic coating structure 3 through the insulation extending portion 22.

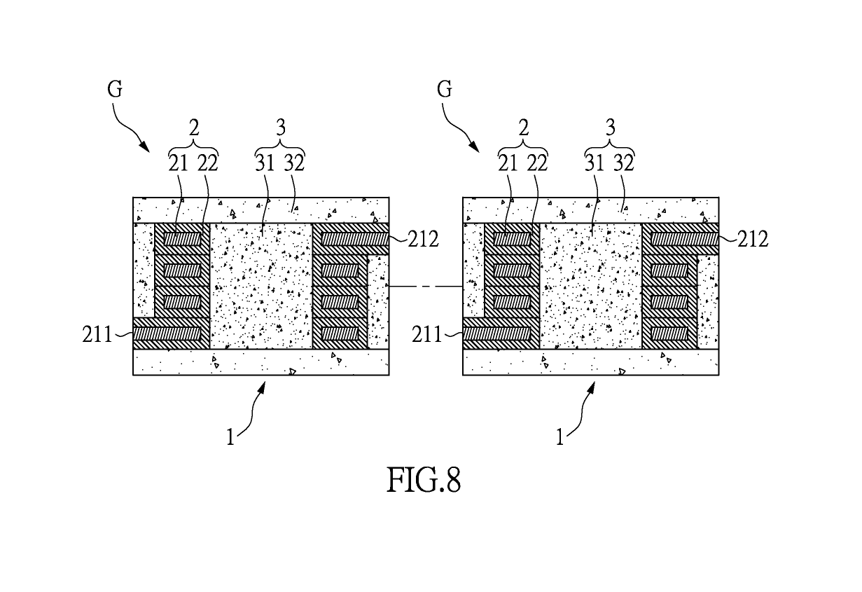

Subsequently, referring to FIG. 5 and FIG. 8, the step S106 is: cutting the initial magnetic substrate unit 1′, the coil structure unit 2′, and the initial magnetic coating structure unit 3′ along the section line B-B of FIG. 8 to form a plurality of granulated electronic components G (FIG. 8 only shows two granulated electronic components G for example). More particularly, the initial magnetic substrate unit 1′ is cut into the magnetic substrates 1 separated from each other, the coil structure unit 2′ is cut into the coil structures 2 separated from each other, the initial magnetic coating structure unit 3′ is cut into the magnetic coating structures 3 separated from each other, and each granulated electronic component G is composed of the magnetic substrate 1, the coil structure 2, and the magnetic coating structure 3 (S106).

Next, referring to FIG. 5 and FIG. 8, the step S108 is: setting the granulated electronic components G at a predetermined temperature substantially between 200° C. and 900° C. during a densification treatment (process) (S108). For example, when the coil structure 2 includes a conductive metal line and an insulation material for enclosing the conductive metal line, the granulated electronic components G at a predetermined temperature substantially between 150° C. and 300° C. during the densification treatment. When the coil structure 2 includes a plurality of conductive metal foils and insulation layers stacked on top of one another, the granulated electronic components G at a predetermined temperature substantially between 150° C. and 300° C. during the densification treatment. When the coil structure 2 includes a plurality of conductive printed layers and insulation layers stacked on top of one another, the granulated electronic components G at a predetermined temperature substantially between 600° C. and 750° C. during the densification treatment. When the coil structure 2 includes a plurality of conductive electroplated layers and insulation layers stacked on top of one another, the granulated electronic components G at a predetermined temperature substantially between 150° C. and 300° C. during the densification treatment.

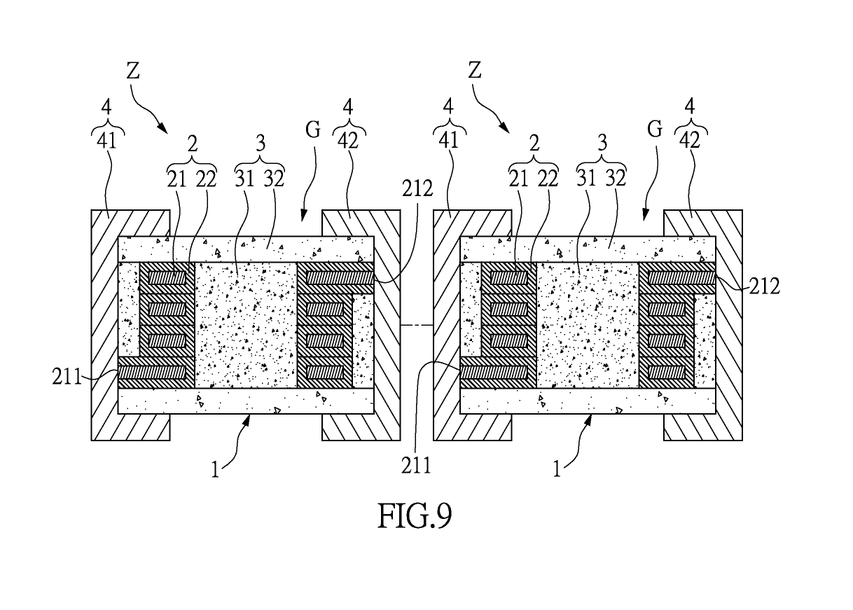

Finally, referring to FIG. 5 and FIG. 9, the step S110 is: respectively forming a plurality of terminal electrode structures 4 on the granulated electronic components G, the terminal electrode structure 4 including a first terminal electrode portion 41 and a second terminal electrode portion 42 respectively disposed on two opposite lateral sides of the granulated electronic component G to finish the manufacture of the customized SMD power inductor Z (S110). More particularly, the conductive extending portion 21 has a first conductive terminal 211 and a second conductive terminal 212 opposite to the first conductive terminal 211, the first conductive terminal 211 and the second conductive terminal 212 of the conductive extending portion 21 both are exposed from the middle coating layer 31 to respectively electrically contacting the first conductive terminal portion 41 and the second terminal electrode portion 42. In addition, the first terminal electrode portion 41 is disposed on a lateral side of the middle coating layer 31 for enclosing a portion of the magnetic substrate 1 and a portion of the top coating layer 32, and the second terminal electrode portion 42 is disposed on another lateral side of the middle coating layer 31 for enclosing another portion of the magnetic substrate 1 and another portion of the top coating layer 32.

In conclusion, in one of embodiments, the electrical property of the customized SMD power inductor Z can be adjusted or determined to pass muster with customer according to numerical values of the first predetermined relative permeability (μ1), the second predetermined relative permeability (μ2), the third predetermined relative permeability (μ3), and the fourth predetermined relative permeability (μ4), in order to pass muster with different customers. In another one of embodiments, the electrical property of the customized SMD power inductor Z can be adjusted or determined according to the first predetermined soft magnetic material, the second predetermined soft magnetic material, the third predetermined soft magnetic material, and the fourth predetermined soft magnetic material, in order to pass muster with different customers.

The aforementioned descriptions merely represent the preferred embodiments of the instant disclosure, without any intention to limit the scope of the instant disclosure which is fully described only within the following claims. Various equivalent changes, alterations or modifications based on the claims of the instant disclosure are all, consequently, viewed as being embraced by the scope of the instant disclosure.

What is claimed is:

1. A customized SMD power inductor, comprising:
a magnetic substrate;
a coil structure disposed on the magnetic substrate, wherein the coil structure includes a conductive extending portion and an insulation extending portion for enclosing the conductive extending portion, the conductive extending portion and the insulation extending portion are extended along a predetermined track, and the conductive extending portion has a first conductive terminal and a second conductive terminal opposite to the first conductive terminal;
a magnetic coating structure disposed on the magnetic substrate to cover the coil structure, wherein the magnetic coating structure includes a middle coating layer disposed on the magnetic substrate and connected to the insulation extending portion and a top coating layer disposed on the coil structure and the middle coating layer, the conductive extending portion is insulated from the magnetic coating structure through the insulation extending portion, the first conductive terminal and the second conductive terminal of the conductive extending portion both are exposed from the middle coating layer, and the middle coating layer has a surrounding perimeter portion; and
a terminal electrode structure including a first terminal electrode portion electrically contacting the first conductive terminal and a second terminal electrode portion corresponding to the first terminal electrode portion and electrically contacting the second conductive terminal, wherein the first terminal electrode portion is disposed on a lateral side of the middle coating layer for enclosing a portion of the magnetic substrate and a portion of the top coating layer, and the second terminal electrode portion is disposed on another lateral side of the middle coating layer for enclosing another portion of the magnetic substrate and another portion of the top coating layer;
wherein the magnetic substrate has a first predetermined relative permeability, the surrounding perimeter portion has a second predetermined relative permeability, the middle coating layer has a third predetermined relative permeability, and the top coating layer has a fourth predetermined relative permeability, the third predetermined relative permeability of the middle coating layer is larger than or equal to the fourth predetermined relative permeability of the top coating layer, the fourth predetermined relative permeability of the top coating layer is larger than or equal to the first predetermined relative permeability of the magnetic substrate, and the first predetermined relative permeability of the magnetic substrate is larger than or equal to the second predetermined relative permeability of the surrounding perimeter portion;
wherein the electrical property of the customized SMD power inductor is adjusted according to numerical values of the first predetermined relative permeability, the second predetermined relative permeability, the third predetermined relative permeability, and the fourth predetermined relative permeability.

2. The customized SMD power inductor of claim 1, wherein the middle coating layer has a middle filling portion seamlessly connected to the insulation extending portion and surrounded by the insulation extending portion, the surrounding perimeter portion is seamlessly connected to the insulation extending portion for surrounding the insulation extending portion, and the top coating layer is seamlessly connected to the middle filling portion, the surrounding perimeter portion, and the insulation extending portion, wherein the range of any one of the first predetermined relative permeability, the second predetermined relative permeability, the third predetermined relative permeability, and the fourth predetermined relative permeability is substantially between 1 and 53.

3. The customized SMD power inductor of claim 1, wherein the magnetic substrate is made of a first predetermined soft magnetic material, the insulation extending portion is made of a second predetermined soft magnetic material, the middle coating layer is made of a third predetermined soft magnetic material, the top coating layer is made of a fourth predetermined soft magnetic material, and the first predetermined soft magnetic material, the second predetermined soft magnetic material, the third predetermined soft magnetic material, and the fourth predetermined soft magnetic material are totally different from each other or partially different from each other, wherein the conductive extending portion is one of a conductive metal line, a conductive metal foil, a conductive printed layer, and a conductive electroplated layer, and the conductive extending portion is extended along an upward spiral track or an upward meandering track.

4. A customized SMD power inductor, comprising:
a magnetic substrate;
a coil structure disposed on the magnetic substrate, wherein the coil structure includes a conductive extending portion and an insulation extending portion for enclosing the conductive extending portion, the conductive extending portion and the insulation extending portion are extended along a predetermined track, and the conductive extending portion has a first conductive terminal and a second conductive terminal opposite to the first conductive terminal;
a magnetic coating structure disposed on the magnetic substrate to cover the coil structure, wherein the magnetic coating structure includes a middle coating layer disposed on the magnetic substrate and connected to the insulation extending portion and a top coating layer disposed on the coil structure and the middle coating layer, the conductive extending portion is insulated from the magnetic coating structure through the insulation extending portion, the first conductive terminal and the second conductive terminal of the conductive extending portion both are exposed from the middle coating layer, and the middle coating layer has a surrounding perimeter portion; and
a terminal electrode structure including a first terminal electrode portion electrically contacting the first conductive terminal and a second terminal electrode portion corresponding to the first terminal electrode portion and electrically contacting the second conductive terminal, wherein the first terminal electrode portion is disposed on a lateral side of the middle coating layer for enclosing a portion of the magnetic substrate and a portion of the top coating layer, and the second terminal electrode portion is disposed on another lateral side of the middle coating layer for enclosing another portion of the magnetic substrate and another portion of the top coating layer;
wherein the magnetic substrate is made of a first predetermined soft magnetic material, the insulation extending portion is made of a second predetermined soft magnetic material, the middle coating layer is made of a third predetermined soft magnetic material, the top coating layer is made of a fourth predetermined soft magnetic material, and the first predetermined soft magnetic material, the second predetermined soft magnetic material, the third predetermined soft magnetic material, and the fourth predetermined soft magnetic material are totally different from each other or partially different from each other;
wherein the electrical property of the customized SMD power inductor is adjusted according to the first predetermined soft magnetic material, the second predetermined soft magnetic material, the third predetermined soft magnetic material, and the fourth predetermined soft magnetic material.

5. The customized SMD power inductor of claim 4, wherein the middle coating layer has a middle filling portion seamlessly connected to the insulation extending portion and surrounded by the insulation extending portion, the surrounding perimeter portion is seamlessly connected to the insulation extending portion for surrounding the insulation extending portion, and the top coating layer is seamlessly connected to the middle filling portion, the surrounding perimeter portion, and the insulation extending portion, wherein the conductive extending portion is one of a conductive metal line, a conductive metal foil, a conductive printed layer, and a conductive electroplated layer, and the conductive extending portion is extended along an upward spiral track or an upward meandering track.

6. The customized SMD power inductor of claim 4, wherein the magnetic substrate has a first predetermined relative permeability, the surrounding perimeter portion has a second predetermined relative permeability, the middle coating layer has a third predetermined relative permeability, and the top coating layer has a fourth predetermined relative permeability, the third predetermined relative permeability of the middle coating layer is larger than or equal to the fourth predetermined relative permeability of the top coating layer, the fourth predetermined relative permeability of the top coating layer is larger than or equal to the first predetermined relative permeability of the magnetic substrate, and the first predetermined relative permeability of the magnetic substrate is larger than or equal to the second predetermined relative permeability of the surrounding perimeter portion, wherein the range of any one of the first predetermined relative permeability, the second predetermined relative permeability, the third predetermined relative permeability, and the fourth predetermined relative permeability is substantially between 1 and 53.

7. A method of manufacturing a customized SMD power inductor, comprising:
providing an initial magnetic substrate unit, wherein the initial magnetic substrate unit is composed of a plurality of magnetic substrates;
forming a coil structure unit on the initial magnetic substrate unit, wherein the coil structure unit is composed of a plurality of coil structures respectively disposed on the magnetic substrate, wherein each coil structure includes a conductive extending portion and an insulation extending portion for enclosing the conductive extending portion, and the conductive extending portion and the insulation extending portion are extended along a predetermined track;
forming an initial magnetic coating structure unit on the initial magnetic substrate unit to cover the coil structure unit, wherein the initial magnetic coating structure unit is composed of a plurality of magnetic coating structures respectively disposed on the magnetic substrates to respectively cover the coil structures, each magnetic coating structure includes a middle coating layer disposed on the magnetic substrate and connected to the insulation extending portion and a top coating layer disposed on the coil structure and the middle coating layer, the conductive extending portion is insulated from the magnetic coating structure through the insulation extending portion, and the middle coating layer has a surrounding perimeter portion;
cutting the initial magnetic substrate unit, the coil structure unit, and the initial magnetic coating structure unit to form a plurality of granulated electronic components, wherein the initial magnetic substrate unit is cut into the magnetic substrates separated from each other, the coil structure unit is cut into the coil structures separated from each other, the initial magnetic coating structure unit is cut into the magnetic coating structures separated from each other, and each granulated electronic component is composed of the magnetic substrate, the coil structure, and the magnetic coating structure;
setting the granulated electronic components at a predetermined temperature substantially between 200° C. and 900° C. during a densification treatment; and
respectively forming a plurality of terminal electrode structures on the granulated electronic components, wherein the terminal electrode structure includes a first terminal electrode portion and a second terminal electrode portion respectively disposed on two opposite lateral sides of the granulated electronic component to finish the manufacture of the customized SMD power inductor;
wherein the conductive extending portion has a first conductive terminal and a second conductive terminal opposite to the first conductive terminal, the first conductive terminal and the second conductive terminal of the conductive extending portion both are exposed from the middle coating layer to respectively electrically contacting the first conductive terminal portion and the second terminal electrode portion, wherein the first terminal electrode portion is disposed on a lateral side of the middle coating layer for enclosing a portion of the magnetic substrate and a portion of the top coating layer, and the second terminal electrode portion is disposed on another lateral side of the middle coating layer for enclosing another portion of the magnetic substrate and another portion of the top coating layer.

8. The method of claim 7, wherein the magnetic substrate has a first predetermined relative permeability, the surrounding perimeter portion has a second predetermined relative permeability, the middle coating layer has a third predetermined relative permeability, and the top coating layer has a fourth predetermined relative permeability, the third predetermined relative permeability of the middle coating layer is larger than or equal to the fourth predetermined relative permeability of the top coating layer, the fourth predetermined relative permeability of the top coating layer is larger than or equal to the first predetermined relative permeability of the magnetic substrate, and the first predetermined relative permeability of the magnetic substrate is larger than or equal to the second predetermined relative permeability of the surrounding perimeter portion, wherein the range of any one of the first predetermined relative permeability, the second predetermined relative permeability, the third predetermined relative permeability, and the fourth predetermined relative permeability is substantially between 1 and 53, wherein the electrical property of the customized SMD power inductor is adjusted according to numerical values of the first predetermined relative permeability, the second predetermined relative permeability, the third predetermined relative permeability, and the fourth predetermined relative permeability.

9. The method of claim 7, wherein the magnetic substrate is made of a first predetermined soft magnetic material, the insulation extending portion is made of a second predetermined soft magnetic material, the middle coating layer is made of a third predetermined soft magnetic material, the top coating layer is made of a fourth predetermined soft magnetic material, and the first predetermined soft magnetic material, the second predetermined soft magnetic material, the third predetermined soft magnetic material, and the fourth predetermined soft magnetic material are totally different from each other or partially different from each other, wherein the electrical property of the customized SMD power inductor is adjusted according to the first predetermined soft magnetic material, the second predetermined soft magnetic material, the third predetermined soft magnetic material, and the fourth predetermined soft magnetic material.

10. The method of claim 7, wherein the middle coating layer has a middle filling portion seamlessly connected to the insulation extending portion and surrounded by the insulation extending portion, the surrounding perimeter portion is seamlessly connected to the insulation extending portion for surrounding the insulation extending portion, and the top coating layer is seamlessly connected to the middle filling portion, the surrounding perimeter portion, and the insulation extending portion, wherein the conductive extending portion is one of a conductive metal line, a conductive metal foil, a conductive printed layer, and a conductive electroplated layer, and the conductive extending portion is extended along an upward spiral track or an upward meandering track.
